(19) United States
(12) Patent Application Publication
(10) Pub. No.: US 2005/0239472 A1
(43) Pub. Date: Oct. 27, 2005

(54) Allocation method and controller

(76) Inventor: Chao Wei, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/983,331

(22) Filed: Nov. 8, 2004

(30) Foreign Application Priority Data
Apr. 21, 2004 (FI) 20045142

(51) Int. Cl. H04Q 7/20

(52) U.S. Cl. 455/452.2; 455/439

(57) ABSTRACT

A controller of a communication system includes means for estimating at least one parameter characterizing signal quality in a cell of the communication system. The controller also includes means for estimating at least one parameter characterizing signal quality in at least one neighbouring cell and means for comparing the estimated at least one parameter characterizing signal quality of the cell to a predetermined handover limit value. The controller also includes means for evaluating the influence of the interference change caused by handover on the at least one neighbouring cell and means for selecting a handover target channel based on the neighbouring cell parameter estimation and on the interference change influence evaluation.

### FIELD

The invention relates to an allocation method of a communication system and a controller of a communication system.

### BACKGROUND

The UMTS (Universal Mobile Telecommunications System) Terrestrial Radio Access (UTRA) consists of two modes: FDD (Frequency Division Duplex) and TDD (Time Division Duplex). The TDD mode uses combined time division and code division multiple access schemes, usually referred to as TD-CDMA. The TDD mode is particularly suitable for asymmetric traffic and systems having small cell sizes, such as systems used in hot spot areas or indoors.

In TDD systems, base stations transmit data in a TDMA (Time Division Multiple Access) mode, which is known as a digital transmission technique in which several signals are interleaved in time for transmission over a common channel. Time interleaving is typically accomplished by dividing the channel into time-slots.

In TDD systems, there are several kinds of handovers: in addition to inter-cell handover, there is also intra-cell handover. The intra-cell handover of the TDD system is usually a handover between different time-slots of the same radio frequency carrier within the same cell. The intra-cell handover is used to balance the load between different time-slots. Time-slot Interference Signal Code Power (ISCP) is typically used as a decision criterion for intra-cell handover.

The target time-slot of the intra-cell handover is, according to prior art methods, the least interfered time-slot. However, the time-slot reallocation has an impact on the quality of service (QoS) of other users served in the least interfered time-slot, especially in adjacent cells.

### BRIEF DESCRIPTION OF THE INVENTION

An object of the invention is to provide an improved method for resource allocation and a controller.

According to an aspect of the invention, there is provided a allocation method of a communication system, comprising: estimating at least one parameter characterizing signal quality in a cell of the communication system; estimating at least one parameter characterizing signal quality in at least one neighbouring cell; comparing the estimated at least one parameter characterizing signal quality of the cell to a predetermined handover limit value; if the at least one parameter characterizing signal quality of the cell exceeds the handover limit value, then evaluating the influence of the interference change caused by handover on the at least one neighbouring cell; and selecting a handover target channel based on the neighbouring cell parameter estimation and on the interference change influence evaluation.

According to another aspect of the invention, there is provided an allocation method of a communication system, comprising: estimating at least one parameter characterizing signal quality in at least one neighbouring cell; evaluating the influence of the interference change caused by handover on the at least one neighbouring cell; and selecting a handover target channel based on the neighbouring cell parameter estimation and on the interference change influence evaluation.

According to another aspect of the invention, there is provided a controller of a communication system, comprising: means for estimating at least one parameter characterizing signal quality in a cell of the communication system; means for estimating at least one parameter characterizing signal quality in at least one neighbouring cell; means for comparing the estimated at least one parameter characterizing signal quality of the cell to a predetermined handover limit value; means for evaluating the influence of the interference change caused by handover on the at least one neighbouring cell; means (608) for selecting a handover target channel based on the neighbouring cell parameter estimation and on the interference change influence evaluation.

According to another aspect of the invention, there is provided a controller of a communication system, comprising: means for estimating at least one parameter characterizing signal quality in at least one neighbouring cell; means for evaluating the influence of the interference change caused by handover on the at least one neighbouring cell; means for selecting a handover target channel based on the neighbouring cell parameter estimation and on the interference change influence evaluation.

According to another aspect of the invention, there is provided a controller of a communication system being configured to: estimate at least one parameter characterizing signal quality in a cell of the communication system; estimate at least one parameter characterizing signal quality in at least one neighbouring cell; compare the estimated at least one parameter characterizing signal quality of the cell to a predetermined handover limit value; evaluate the influence of the interference change caused by handover on the at least one neighbouring cell; select a handover target channel based on the neighbouring cell parameter estimation and on the interference change influence evaluation.

According to another aspect of the invention, there is provided a controller of a communication system being configured to: estimate at least one parameter characterizing signal quality in at least one neighbouring cell; evaluate the influence of the interference change caused by handover on the at least one neighbouring cell; select a handover target channel based on the neighbouring cell parameter estimation and on the interference change influence evaluation.

The method and system of the invention provide several advantages. One embodiment of the invention provides a more efficient method for load balancing in TDD (time division duplex) systems and for preventing consecutive handovers caused by interference increase.

### LIST OF DRAWINGS

In the following, the invention will be described in greater detail with reference to the embodiments and the accompanying drawings, in which

FIG. 1 shows an example of a communication system,

FIG. 2 is a flow chart,

FIG. 3 illustrates a prior art example of time-slot selection,

FIG. 4 is another flow chart,

FIG. 5 illustrates time-slot selection according to an embodiment, and

FIG. 6 shows an example of a radio network controller (RNC).

### DESCRIPTION OF EMBODIMENTS

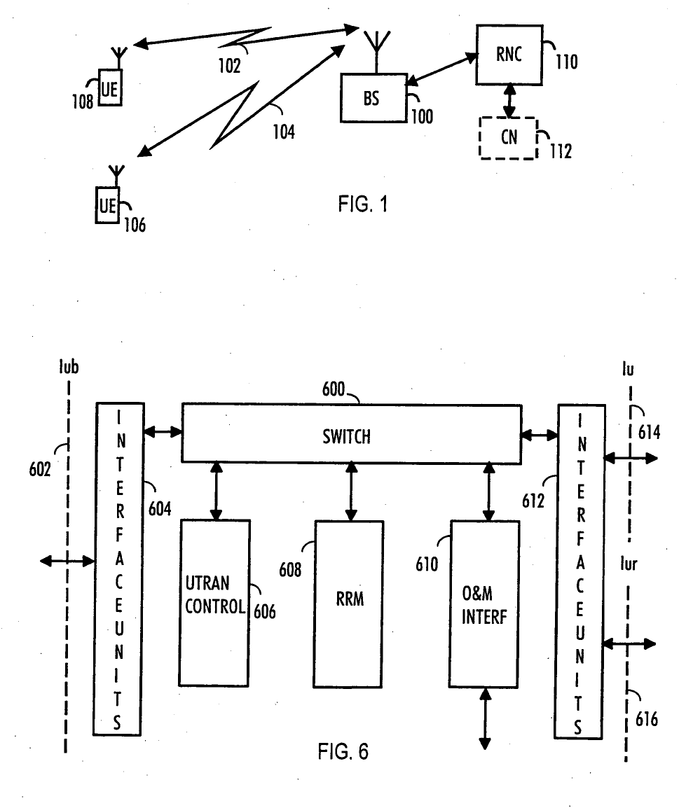

An example of a communication system in which embodiments of the invention can be applied is examined with reference to FIG. 1. The present invention can be applied in various wireless communication systems. One example of such a communication system is UMTS (Universal Mobile Telecommunications System) radio access network. It is a radio access network which includes CDMA (code division multiple access) technology and can also offer real-time circuit and packet switched services. It is also possible to combine time division and code division multiple access schemes. This kind of system, for instance, is a TD-CDMA system using TDD mode. The TDD mode is particularly suitable for asymmetric traffic and systems having small cell sizes, such as systems used in hot spot areas or indoors.

It is clear to a person skilled in the art that the method according to the invention can be applied to systems utilizing different modulation methods or air interface standards. The communication system may also include sub-systems.

FIG. 1 is a simplified illustration of a digital data transmission system to which the solution according to the invention is applicable. This is a part of a cellular radio system, which comprises a base station (or a node B) 100 having bi-directional radio links 102 and 104 to subscriber terminals 106 and 108. The subscriber terminals may be fixed, vehicle-mounted or portable. The base station includes transceivers, for instance. From the transceivers of the base station, there is a connection to an antenna unit, which establishes the bi-directional radio links to the subscriber terminal. The base station is further connected to a radio network controller (RNC) 110, which transmits the connections of the terminals to other parts of the network. The radio network controller controls in a centralized manner several B-nodes connected to it. The radio network controller is further connected to a core network CN 112. Depending on the system, the counterpart on the CN side can be a mobile services switching centre (MSC), a media gateway (MGW) or a serving GPRS (general packet radio service) support node (SGSN).

The cellular radio system can also communicate with other networks, such as a public switched telephone network or the Internet.

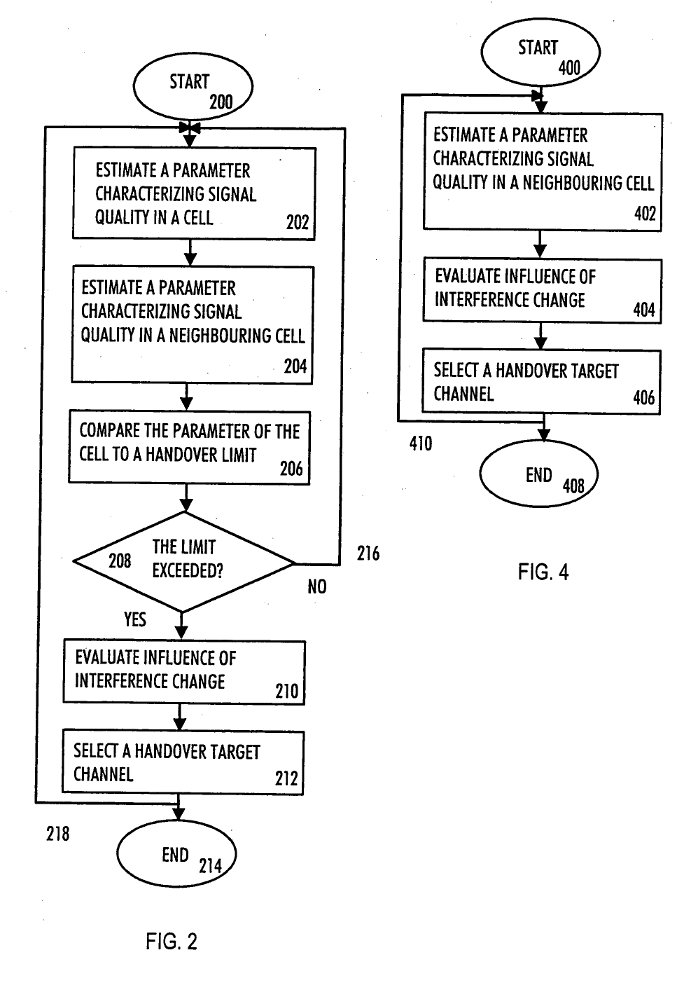

An embodiment of an allocation method of a communication system is described by means of FIG. 2. In an embodiment, the radio network controller (RNC) determines the target time-slot for intra-cell handover on the basis of interference level and/or path-loss information of neighbouring cells. Thus the performance degradation of other users can be minimized.

The embodiment starts in block 200.

In block 202, at least one parameter characterizing signal quality in a cell of the communication system is estimated. The parameter can, for instance, be interference level and/or path loss. Several well-known prior art methods for interference level estimation and for path loss estimation in a cellular system exist, and therefore they are not explained here in further detail. In TD-CDMA, Time-slot Interference Signal Code Power (ISCP) is typically determined. Usually, the user terminal estimates the interference level of the signal it receives and then sends a report to the base station and/or the base station carries out interference level estimation.

In block 204, at least one parameter characterizing signal quality in at least one neighbouring cell is estimated. Neighbouring cells are typically called adjacent cells or neighbour cells. The parameter characterizing signal quality can, for instance, be interference level and/or path loss. Several well-known prior art methods for interference level estimation and for path loss estimation in a cellular system exist, and therefore they are not explained here in further detail. Usually, the user terminal estimates the interference level of the signal it receives and then sends a report to the base station or the base station carries out interference level estimation.

User terminals and base stations measure radio signals they receive for making lists of cells suitable for handover.

In practice, typically, the cell with a minimum path-loss is included in an active set. Like handovers, also set modifications are controlled by the network.

In block 206, the estimated parameter characterizing signal quality of the cell is compared to a predetermined handover limit value. In TD-CDMA, the handover limit value is usually set for Time-slot Interference Signal Code Power (ISCP).

If at least one parameter characterizing signal quality of the cell exceeds the handover limit value, in block 208, then the influence of the interference change caused by handover on the at least one neighbouring cell is evaluated in block 210.

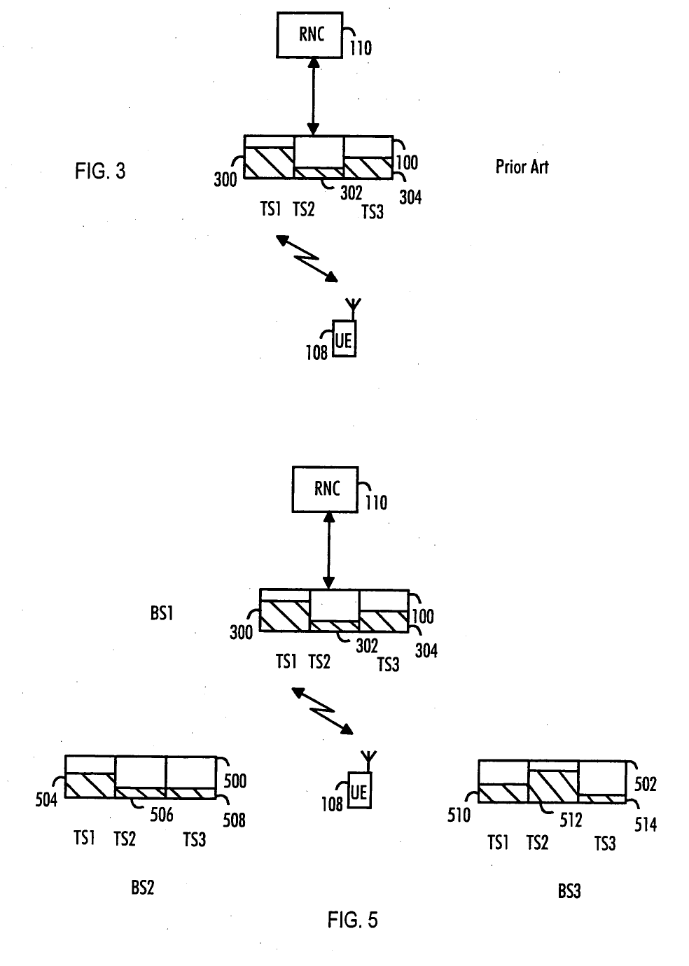

Next, a prior art example of intra-cell handover is examined by means of FIG. 3. The base station 100 the user terminal 108 has a radio connection to has three time-slots available: T1 300, T2 302 and T3 304. Time-slot T1 300 is allocated to the user terminal. Since interference in the time-slot T1 300 is higher than the set handover limit, the radio network controller 110 searches for a new less interfered time-slot for the user terminal. The interference level in time-slot T2 302 of base station 100 is the lowest and therefore the intra-cell handover is made to this time-slot.

The time-slot reallocation, however, typically also has influence on other users of the handover target time-slot, especially on the users in neighbouring cells. In TDD systems an advanced reception technique, such as joint detection, is typically used and thus the interference in the same cell is mitigated. Therefore, intra-cell handovers usually influence less the users in the same cell than the users in the neighbouring cells.

It is possible that the interference increase caused by the new user inflicts on the handover limit exceeding in other cells, leading to a series of intra-cell handovers which can make the communication system unsteady.

Hence in the embodiment of the allocation method according to the invention, also the influence of the interference change caused by handover on the at least one neighbouring cell is evaluated. Next an example of the evaluation process is explained in further detail by means of FIG. 5.

Assuming that user terminal 108 is an initiator of uplink intra-cell handover, base station 100 is in the active set and base stations 500 and 502 are neighbouring cells. Base station BS2 500 has three time slots: TS1 504, TS2 506 and TS3 508. Base station BS3 502 also has three time slots: TS1 510, TS2 512 and TS3 514.

Base station BS3 502 has smaller path−loss in the user terminal's point of view compared with base station BS2 500. Time-slot T1 300 of base station 100 is allocated to the user terminal. Since interference in time-slot T1 300 is higher than the set handover limit, the radio network controller 110 searches for a new less interfered time-slot for the user terminal. The interference level in time-slot T2 302 of base station 100 is the lowest but in base station BS3 502, the interference level of time slot T2 512 is near the handover limit.

Interference in neighbouring cells after intra-cell handover for a neighbouring cell i and a time-slot j can be estimated as follows:
ISCP_{BSi,TSj,new}=ISCP_{BSi,TSj,old}+RX_Power_{UE,BS1,TSj}−Δpath-loss_{BSi,BS1}, (1)
wherein
ISCP_{BSi,TSj,old} is Time-slot Interference Signal Code Power of a selected time-slot of a pre-determined neighbour cell before hand-over,
RX_Power_{UE,BS1,TSj} is the estimated power for the user terminal in the handover target time slot and
Δpath-loss_{BSi,BS1} is the path-loss difference between the predetermined neighbouring cell and the active cell of the handover candidate, that is to say:
Δpath-loss_{BSi,BS1}=path-loss_{BSi,UE1}−path-loss_{BS1,UE1}.

The Interference level of the neighbouring cell in each time slot after handover is compared to the set handover limit (typically ISCP) to decide whether the cell is suitable for handover. If all time-slots of the neighbouring cells have low interference level even after handover, the least interfered time-slot in a cell in the active set is selected as the target time-slot.

In uplink, when a time-slot reallocation is carried out, the most affected cell is typically the cell of the neighbour set which has the smallest path-loss to the handover candidate.

In downlink, usually, the most interfered users of the intra-cell handover are the downlink users who receive a signal in the same time-slot as the handover target time-slot. Typically, the smaller the path-loss difference between the interfered downlink user and the active cell of the handover candidate is, the higher the interference increase will be. Based on path-loss measurements carried out by user terminals, the network (usually a radio network controller) is able to obtain information on downlink users in neighbouring cells and to decide which of them are close to the current cell of the handover candidate user terminal.

Interference increase for the neighbouring cell user after intra-cell handover for a user i and a time-slot j can be estimated as follows:
ISCP_{UEi,TSj,new}=ISCP_{UEi,TSj,old}+TX_Power_{UE1,BS1,TSj}−path-loss_{BS1,UEi}, (2)
wherein
ISCP_{UEi,TSj,old} is Time-slot Interference Signal Code Power of a selected neighbour cell user before hand-over,
TX_Power_{UE1,BS1,TSj} is the estimated transmission power of a handover candidate user in the handover target time-slot j and
path-loss_{BS1,UE1} is the path-loss between the interfered downlink user i and the active cell of the handover candidate.

Another way of implementing the above explained allocation method is utilising the fact that usually Δpath-loss_{BSi,BS1} of equation (1) is the same for all time-slots in the neighbouring cells of the handover candidate and RX_Power_{UE,TSj} of equation (1) is related to the interference level in each slot of the current cell of the handover candidate. Therefore it is possible only to determine the sum of interferences in the selected neighbouring cells and in the current cell of the handover candidate and choose the time-slot which has the smallest interference. Also a weighting factor a can be implemented to model the importance of the current cell of the handover candidate to the neighbouring cell for a time-slot j as follows:
α·ISCP_{BSi,TSj,old}+(1−α)ISCP_{BS1,TSj}, (3)
wherein
ISCP_{BSi,TSj,old} is Time-slot Interference Signal Code Power of a selected time-slot of a pre-determined neighbour cell before hand-over and
ISCP_{BS1,TSj} is Time-slot Interference Signal Code Power of the selected time-slot of the handover candidate's current cell before handover.

In block 212, a handover target channel is selected based on the neighbouring cell parameter estimation and on the interference change influence evaluation. The handover target channel may, for instance, be a time-slot. The network (typically a radio network controller, RNC) decides on the handover target channel on the basis of the neighbouring cell parameter estimation (block 204) and on the interference change influence evaluation (block 208). The main purpose of the handover target channel selection is to minimize the risk of a series of consequent handovers due to interference increase.

In the example of FIG. 5, the best choice for a handover target time-slot is time-slot TS3 304 of base station BS1 100, since the handover limit is not exceeded in any examined cell after the intra-cell handover and thus the series of consecutive handovers can be avoided.

If all time-slots have a high interference level after intra-cell handover, inter-cell handover may be performed.

The method ends in block 214. Arrow 216 depicts one possibility of repeating the embodiment. Arrow 218 depicts another possibility of repeating the embodiment.

Next, another embodiment of the allocation method is explained by means of FIG. 4. In an embodiment, the radio network controller (RNC) determines the target time-slot for intra-cell handover on the basis of interference level and/or path loss information of neighbouring cell. Thus the performance degradation of other users can be minimized.

The embodiment starts in block 400.

In block 402, at least one parameter characterizing signal quality in a cell of the communication system is estimated. The parameter can, for instance, be interference level and/or path loss. Several well-known prior art methods for interference level estimation and for path loss estimation in a cellular system exist, and therefore they are not explained here in further detail. In TD-CDMA, Time-slot Interference Signal Code Power (ISCP) is typically determined. Usually, the user terminal estimates the interference level of the signal it receives and then sends a report to the base station and/or the base station carries out interference level estimation.

User terminals and base stations measure radio signals they receive for making lists of cells suitable for handover.

In practice, typically, the cell with a minimum path-loss is included in an active set. Like handovers, also set modifications are controlled by the network.

The influence of the interference change caused by handover on the at least one neighbouring cell is evaluated in block 404.

Next, a prior art example of intra-cell handover is examined by means of FIG. 3. The base station 100 the user terminal 108 has a radio connection to has three time-slots available: T1 300, T2 302 and T3 304. Time-slot T1 300 is allocated to the user terminal. Since interference in the time-slot T1 300 is higher than the set handover limit, the radio network controller 110 searches for a new less interfered time-slot for the user terminal. The interference level in time-slot T2 302 of base station 100 is the lowest and therefore the intra-cell handover is made to this time-slot.

The time-slot reallocation, however, typically also has influence on other users of the handover target time-slot, especially on the users in neighbouring cells. It is possible that the interference increase caused by the new user inflicts on the handover limit exceeding in other cells, leading to a series of intra-cell handovers which can make the communication system unsteady.

Hence in the embodiment of the allocation method according to the invention, also the influence of the interference change caused by handover on the at least one neighbouring cell is evaluated. Next an example of the evaluation process is explained in further detail by means of FIG. 5.

Assuming that user terminal 108 is an initiator of uplink intra-cell handover, base station 100 is in the active set and base stations 500 and 502 are neighbouring cells. Base station BS2 500 has three time slots: TS1 504, TS2 506 and TS3 508. Base station BS3 502 also has three time slots: TS1 510, TS2 512 and TS3 514.

Base station BS3 502 has a smaller path-loss from the user terminal's point of view compared with base station BS2 500. Time-slot T1 300 of base station 100 is allocated to the user terminal. Since interference in time-slot T1 300 is higher than the set handover limit, the radio network controller 110 searches for a new less interfered time-slot for the user terminal. The interference level in time-slot T2 302 of base station 100 is the lowest but in base station BS3 502, the interference level of time slot T2 512 is near the handover limit.

Interference in the neighbouring cells after intra-cell handover for a neighbouring cell i and a time-slot j can be estimated as follows:
ISCP_{BSi,TSj,new}=ISCP_{BSi,TSj,old}+RX_Power_{UE,BS1,TSj}−Δpath-loss_{BSi,BS1}, (1)
wherein
ISCP_{BSi,TSj,old} is Time-slot Interference Signal Code Power of a selected time-slot of a pre-determined neighbour cell before hand-over,
RX_Power_{UE,BS1,TSj} is the estimated power for the user terminal in the handover target time slot and
Δpath-loss_{BSi,BS1} is the path-loss difference between the predetermined neighbouring cell and the active cell of the handover candidate, that is to say:
Δpath-loss_{BSi,BS1}=path-loss_{BSi,UE1}−path-loss_{BS1,UE1}.

The Interference level of the neighbouring cell in each time slot after handover is compared to set handover limit (typically ISCP) to decide whether the cell is suitable for handover. If all time-slots of the neighbouring cell have low interference level even after handover, the least interfered time-slot in a cell in the active set is selected as the target time-slot.

In uplink, when a time-slot reallocation is carried out, the most affected cell is typically the cell of the neighbour set which has the smallest path-loss to the handover candidate.

In downlink, usually, the most interfered users of the intra-cell handover are the downlink users who receive a signal in the same time-slot as the handover target time-slot. Typically, the smaller the path-loss difference between the interfered downlink user and the active cell of the handover candidate is, the higher the interference increase will be. Based on path-loss measurements carried out by user terminals, the network (usually a radio network controller) is able to obtain information on downlink users in the neighbouring cells and to decide which of them are close to the current cell of the handover candidate user terminal.

Interference increase for the neighbouring cell user after intra-cell handover for a user i and a time-slot j can be estimated as follows:
ISCP_{UEi,TSj,new}=ISCP_{UEi,TSj,old}+TX_Power_{UE1,BS1,TSj}−path-loss_{BS1,UEi}, (2)
wherein
ISCP_{UEi,TSj,old} is Time-slot Interference Signal Code Power of a selected neighbour cell user before hand-over,
TX_Power_{UE1,BS1,TSj} is the estimated transmission power of a handover candidate user in the handover target time-slot j and
path-loss_{BS1,UEi} is the path-loss between the interfered downlink user i and the active cell of the handover candidate.

Another way of implementing the above explained allocation method is utilising the fact that usually Δpath-loss_{BSi,BS1} of equation (1) is the same for all time-slots in neighbouring cells of the handover candidate and RX_Power_{UE,TSj} of equation (1) is related to the interference level in each slot of the current cell of the handover candidate. Therefore it is possible to only determine the sum of interferences in the selected neighbouring cells and in the current cell of the handover candidate and to choose the time-slot which has the smallest interference. Also a weighting factor α can be implemented to model the importance of the current cell of the handover candidate to the neighbouring cell for a time-slot j as follows:
α·ISCP_{BSi,TSj,old}+(1−α)ISCP_{BS1,TSj}, (3)
wherein
ISCP_{BSi,TSj,old} is Time-slot Interference Signal Code Power of a selected time-slot of a pre-determined neighbour cell before hand-over and
ISCP_{BS1,TSJ} is Time-slot Interference Signal Code Power of the selected time-slot of the handover candidate's current cell before handover.

In block 406, a handover target channel is selected based on the neighbouring cell parameter estimation and on the interference change influence evaluation. The handover target channel may, for instance, be a time-slot. The network (typically a radio network controller, RNC) decides on the handover target channel on the basis of the neighbouring cell parameter estimation (block 204) and on the interference change influence evaluation (block 208). The main purpose of the handover target channel selection is to minimize the risk of a series of consequent handovers due to interference increase.

In the example of FIG. 5, the best choice for a handover target time-slot is time-slot TS3 304 of base station BS1 100, since the handover limit is not exceeded in any examined cell after the intra-cell handover and thus the series of consecutive handovers can be avoided.

If all time-slots have a high interference level after intra-cell handover, inter-cell handover may be performed.

The embodiment ends in block 408. Arrow 410 depicts one possibility of repeating the embodiment.

The allocation method can also be implemented as part of F-DCA (fast dynamic channel allocation) to allocate time-slots for both a new admitted user and an inter-cell handover user. F-DCA is a dynamic channel management method, which makes the use of radio channels in a cellular network more effective by directing them from one user to another according to the traffic requirements.

Referring to FIG. 6, a simplified block diagram illustrates an example of the logical structure of a radio network controller (RNC). The RNC is the switching and controlling element of UTRAN. It is depicted here as an example of a controller of a communication system.

Switching 600 handles connections between the core network and the user terminal. The radio network controller is located between Iub 602 and Iu 614 interfaces. The network controller is connected to these interfaces via interface units 604, 612. There is also an interface for inter-RNC transmission called Iur 616. The functionality of the radio network controller can be classified into two categories: UTRAN radio resource management 608 and control functions 606. An operation and management interface function 610 serves as a medium for information transfer to and from the network management functions.

Radio resource management is a group of algorithms used to share and manage the radio path connection so that the quality and capacity of the connection are adequate. The most important radio resource management algorithms include handover control, power control, admission control, packet scheduling, and code management as well as time slot allocation for TDD system. The UTRAN control functions handle functions related to the set-up, maintenance and release of a radio connection between the base stations and user terminals. Therefore, the embodiments of the allocation method described above are usually mainly carried out in radio resource block 608. The radio resource block 608 and control functions block 606 can be combined for performing a radio resource control (RRC) unit of a serving radio network controller (SRNC-RRC).

The precise implementation of the radio network controller (RNC) is vendor-dependent.

The disclosed functionalities of the preferred embodiments of the invention can be advantageously implemented by means of software in different parts of the data transmission system.

Even though the invention is described above with reference to an example according to the accompanying drawings, it is clear that the invention is not restricted thereto but it can be modified in several ways within the scope of the appended claims.

1. An allocation method of a communication system, the method comprising:
estimating at least one parameter characterizing signal quality in a cell of a communication system;
estimating another at least one parameter characterizing signal quality in at least one neighbouring cell;
comparing the at least one parameter characterizing signal quality of the cell to a predetermined handover limit value;
evaluating an influence of an interference change caused by handover on the at least one neighbouring cell if the at least one parameter characterizing signal quality in the cell exceeds the predetermined handover limit value; and
selecting a handover target channel based on the estimating step and on the evaluating step.

2. An allocation method of a communication system, the method comprising:
estimating at least one parameter characterizing signal quality in at least one neighbouring cell;
evaluating an influence of an interference change caused by handover on the at least one neighbouring cell; and
selecting a handover target channel based on the estimating step and on the evaluating step.

3. The method of claim 2, wherein the at least one parameter characterizing signal quality in the at least one neighbouring cell comprises at least one of the following parameters: interference level and path-loss.

4. The method of claim 2, wherein the at least one parameter characterizing signal quality in the at least one neighbouring cell comprises interference level parameter time-slot interference signal code power (ISCP).

5. The method of claim 1, further comprising the step of setting the predetermined handover limit value for time-slot interference signal code power (ISCP).

6. The method of claim 2, further comprising the step of estimating the interference in the at least one neighbouring cell after intra-cell handover for neighbouring cell i and time-slot j as follows:
ISCP_{BSi,TSj,new}=ISCP_{BSi,TSj,old}+RX_Power_{UE,BS1,TSj}−Δpath-loss_{BSi,BS1}

7. The method of claim 2, further comprising the step of estimating an interference increase for a neighbouring cell user after intra-cell handover for user i and time-slot j as follows:
ISCP_{UEi,TSj,new}=ISCP_{UEi,TSj,old}+TX_Power_{UE1,BS1,TSj}−path-loss_{BS1,UEi}

8. The method of claim 2, further comprising the step of estimating a sum of interferences in the at least one neighbouring cell and in a current cell of a handover candidate and choosing as the handover target channel, a channel which has a smallest interference.

9. A controller of a communication system, the controller comprising:
first estimating means for estimating at least one parameter characterizing signal quality in a cell of a communication system;
second estimating means for estimating another at least one parameter characterizing signal quality in at least one neighbouring cell of the communication system;
comparing means for estimating the at least one parameter characterizing signal quality in at least one neighbouring cell;
comparing means for comparing the at least one parameter characterizing signal quality of the cell to a predetermined handover limit value;
evaluating means for evaluating an influence of an interference change caused by handover on the at least one neighbouring cell;
selecting means for selecting a handover target channel based on the second estimating means and on the evaluating means.

10. A controller of a communication system, the controller comprising:
estimating means for estimating at least one parameter characterizing signal quality in at least one neighbouring cell;
evaluating means for evaluating an influence of an interference change caused by handover on the at least one neighbouring cell; and
selecting means for selecting a handover target channel based on the estimating means and on the evaluating means.

11. The controller of claim 10, wherein the at least one parameter characterizing signal quality in the at least one neighbouring cell comprises at least one of the following parameters: interference level and path-loss.

12. The controller of claim 10, wherein the at least one parameter characterizing signal quality in the at least one neighbouring cell comprises interference level parameter time-slot interference signal code power (ISCP).

13. The controller of claim 9, wherein the predetermined handover limit value is set for time-slot interference signal code power (ISCP).

14. The controller of claim 10, further comprising means for estimating an interference in neighbouring cells after intra-cell handover for neighbouring cell i and time-slot j as follows:
ISCP_{BSi,TSj,new}=ISCP_{BSi,TSj,old}+RX_Power_{UE,BS1,TSj}−Δpath-loss_{BSi,BS1}

15. The controller of claim 10, further comprising means for estimating an interference increase for a neighbouring cell user after intra-cell handover for user i and time-slot j as follows:
ISCP_{UEi,TSj,new}=ISCP_{UEi,TSj,old}+TX_Power_{UE1,BS1,TSj}−path-loss_{BS1,UEi}

16. The controller of claim 10, further comprising means for estimating a sum of interferences in the at least one neighbouring cell and in a current cell of a handover candidate and choosing as the handover target channel, a channel which has a smallest interference.

17. A controller of a communication system configured to:
estimate at least one parameter characterizing signal quality in a cell of a communication system;
estimate the at least one parameter characterizing signal quality in at least one neighbouring cell;
estimate another at least one parameter characterizing signal quality in at least one neighbouring cell;
compare the at least one parameter characterizing signal quality of the cell to a predetermined handover limit value;
evaluate an influence of an interference change caused by handover on the at least one neighbouring cell; and
select a handover target channel based on the neighbouring cell parameter estimation and on the evaluation.

18. A controller of a communication system configured to:
estimate at least one parameter characterizing signal quality in at least one neighbouring cell; evaluate an influence of an interference change caused by handover on the at least one neighbouring cell;
select a handover target channel based on the neighbouring cell parameter estimation and on the interference change influence evaluation.
